(19) United States
(12) Patent Application Publication
(10) Pub. No.: US 2015/0316832 A1
(43) Pub. Date: Nov. 5, 2015

(54) TERAHERTZ-WAVE GENERATION DEVICE AND MEASUREMENT APPARATUS INCLUDING THE SAME

(71) Applicant: CANON KABUSHIKI KAISHA, Tokyo (JP)

(72) Inventor: Takahiro Sato, Ebina-shi (JP)

(21) Appl. No.: 14/698,569

(22) Filed: Apr. 28, 2015

(30) Foreign Application Priority Data
Apr. 30, 2014 (JP) 2014-093887
Mar. 19, 2015 (JP) 2015-056430

(51) Int. Cl. G02F 1/365; G02F 1/01; G02F 1/35; G01J 1/04; G02F 1/355

(52) U.S. Cl. CPC G02F 1/365; G01J 1/0425; G01J 1/0429; G02F 1/3551; G02F 1/353; G02F 1/0136

(57) ABSTRACT

At least one terahertz-wave generation device configured to generate a terahertz wave includes a polarization control unit configured to control a polarization direction of light from a light source, and a waveguide including a nonlinear optical crystal disposed such that the light having the polarization direction controlled by the polarization control unit is incident on the nonlinear optical crystal. The nonlinear optical crystal emits a terahertz wave upon the light being incident thereon. The polarization control unit is further configured to control an electric-field intensity of the light to be incident on the nonlinear optical crystal in a direction of a Z-axis of the nonlinear optical crystal.

### BACKGROUND OF THE INVENTION

1. Field of the Invention

The present inventions relate to terahertz-wave generation devices that include nonlinear optical crystals for generating terahertz waves and to measurement apparatuses that include such terahertz-wave generation devices.

2. Description of the Related Art

Terahertz waves are electromagnetic waves having a frequency that lies at least somewhere within a band of frequencies ranging from 30 GHz to 30 THz inclusive. In one method, terahertz waves are generated by causing light to be incident on a nonlinear optical crystal so that the terahertz waves are emitted through a nonlinear optical process. In particular, as disclosed in IEEE Journal of Selected Topics in Quantum Electronics, vol. 19, article No. 8500212 (2013), with a method in which generated terahertz waves are extracted through Cherenkov radiation, terahertz waves having a shorter pulse duration can be obtained in a broader band than with a method in which a photoconductive element is used, and thus an improvement in the performance of a measurement apparatus can be expected.

When a detection unit detects terahertz waves emitted from a nonlinear optical crystal and outputs a signal and the outputted signal is then detected by a lock-in amplifier, the intensity of the terahertz waves needs to be modulated so that the intensity of the terahertz waves varies at a prescribed modulation frequency. By detecting a frequency component of the intensity modulation with the lock-in amplifier, a signal corresponding to an instantaneous electric-field intensity of the terahertz waves can be obtained.

The intensity of terahertz waves can be modulated by modulating the intensity of pumping light with a rotating optical chopper before the pumping light reaches a terahertz-wave generation unit. With this method, however, there is a limit to the speed of rotation of the optical chopper, and there is thus a limit to the measurement speed or to the upper limit of the dynamic range of data to be obtained through the measurement. Japanese Patent Laid-Open No. 2013-029461 discloses another method in which the polarization direction of light to be incident on a photoconductive element serving as a terahertz-wave generation unit is modulated. In addition, US 2012/0318983 A1 discloses a method for modulating light by applying an electric field to a waveguide through which the light is propagating.

Generation of terahertz waves with the use of a photoconductive element is based on that a current is generated by an electric field applied to free carriers. Therefore, with the method disclosed in Japanese Patent Laid-Open No. 2013-029461, the excitation efficiency of free carriers in a semiconductor layer excited by light cannot be changed greatly, and the intensity of the terahertz waves to be generated cannot be modulated greatly. Meanwhile, with the method disclosed in US 2012/0318983 A1, the polarization state of the light is changed while the light is propagating through the nonlinear optical crystal, and thus the light is less likely to be modulated, for example, in a case in which most terahertz waves have been outputted at a side of the waveguide through which the light enters the waveguide.

### SUMMARY OF THE INVENTION

At least one embodiment of a terahertz-wave generation device according to an aspect of the present inventions includes a polarization control unit and a waveguide. The polarization control unit is configured to control a polarization direction of light from a light source. The waveguide includes a nonlinear optical crystal disposed such that the light having the polarization direction controlled by the polarization control unit is incident on the nonlinear optical crystal. The nonlinear optical crystal emits a terahertz wave upon the light being incident thereon. The polarization control unit may be further configured to control an electric-field intensity of the light to be incident on the nonlinear optical crystal in a direction of a Z-axis of the nonlinear optical crystal.

According to other aspects of the present inventions, one or more additional terahertz-wave generation devices, one or more measurement apparatuses, one or more methods for generating a terahertz wave and one or more methods for using one or more of the terahertz-wave generation device(s) and/or the measurement apparatus(es) are discussed herein. Further aspects of the present inventions will become apparent from the following description of exemplary embodiments with reference to the attached drawings.

### BRIEF DESCRIPTION OF THE DRAWINGS

FIG. 1 illustrates a configuration of a terahertz-wave generation device according to a first exemplary embodiment.

FIG. 2A is a sectional view of the terahertz-wave generation device according to the first exemplary embodiment.

FIG. 2B is a perspective view of the terahertz-wave generation device according to the first exemplary embodiment.

FIG. 3 is an illustration for describing a configuration of a terahertz-wave generation device and an axial direction of a nonlinear optical crystal according to a second exemplary embodiment.

FIG. 4 is an illustration for describing a configuration of a terahertz-wave generation device and an axial direction of a nonlinear optical crystal according to a third exemplary embodiment.

FIG. 5 is an illustration for describing a configuration of a terahertz-wave generation device and an axial direction of a nonlinear optical crystal according to a fourth exemplary embodiment.

FIG. 6 is an illustration for describing a configuration of a terahertz-wave generation device and an axial direction of a nonlinear optical crystal according to a fifth exemplary embodiment.

FIG. 7 illustrates a configuration of a measurement apparatus according to a sixth exemplary embodiment.

FIG. 8 is an illustration for describing a configuration of a terahertz-wave generation device and an axial direction of a nonlinear optical crystal according to a seventh exemplary embodiment.

FIG. 9A is an illustration for describing a configuration of the terahertz-wave generator and an axial direction of a nonlinear optical crystal according to the first exemplary embodiment.

FIG. 9B is an illustration for describing another configuration of the terahertz-wave generator according to the first exemplary embodiment.

### DESCRIPTION OF THE EMBODIMENTS

### First Exemplary Embodiment

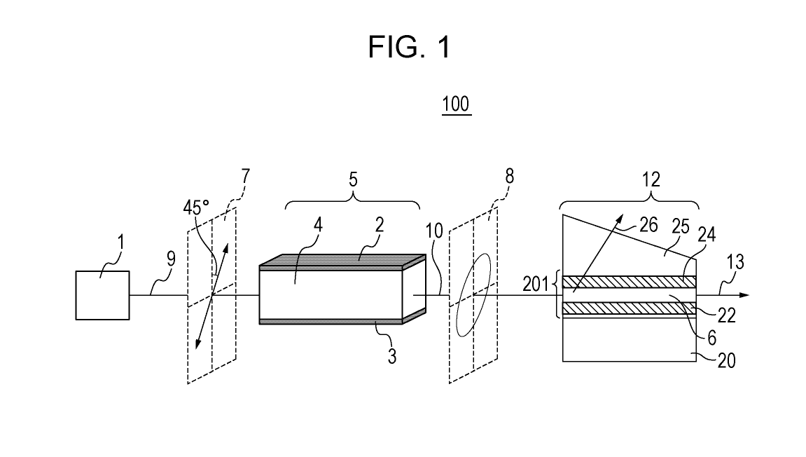

A configuration of a terahertz-wave generation device 100 (hereinafter, referred to as the device 100) according to a first exemplary embodiment will be described with reference to FIG. 1. FIG. 1 illustrates the configuration of the device 100. The device 100 includes a polarization control unit 5 (hereinafter, referred to as the control unit 5), and a terahertz-wave generator 12 (hereinafter, referred to as the generator 12) that includes a waveguide 201 and a coupling member 25. The waveguide 201 includes a nonlinear optical crystal 6 (hereinafter, referred to as the crystal 6) that emits a terahertz wave 26 in response to light 10 from the control unit 5 being incident on the crystal 6. As used in the present specification, a nonlinear optical crystal has second-order nonlinearity and is equivalent to an electro-optic crystal having second-order nonlinearity. In addition, as used in the present specification, a polarization direction is a vibration direction of an electric field of light. The configuration of the generator 12 will be described later in detail.

A light source 1 is a laser device that outputs light 9. It is desirable that the light 9 be femtosecond pulsed laser light. As used in the present specification, femtosecond pulsed laser light is ultrashort pulsed laser light with a pulse duration in a range from 1 fs to 100 fs inclusive. In the present exemplary embodiment, a laser device that outputs femtosecond pulsed laser light at a central wavelength of 1.55 μm, with a pulse duration of 20 fs, and with a repetition rate of 50 MHz is used. However, the wavelength may be in a 1.06-μm band, and the pulse duration and the repetition rate are not limited to the aforementioned values.

It is desirable that a polarization state 7 of the light 9 outputted from the light source 1 be substantially linear with a polarization extinction ratio of no less than 20 dB, but the polarization extinction ratio may less than 20 dB. In addition, the light 9 may be chirped so as to reduce an influence of dispersion in the control unit 5. When two light beams with different frequencies are made to be incident on the crystal 6 so as to generate the terahertz wave 26 through difference frequency generation, the light source 1 may be constituted by a two-wavelength light source or a frequency-comb light source that generates a continuous wave.

The control unit 5 controls the polarization direction of the light 9 from the light source 1. The control unit 5 emits the light 10 whose polarization direction has been adjusted. The control unit 5 includes an electrode 2, an electrode 3, and a nonlinear optical crystal 4 (hereinafter, referred to as the crystal 4), and the crystal 4 is disposed between the electrode 2 and the electrode 3. The control unit 5 controls the polarization direction of the light 9 from the light source 1 by applying a voltage having a desired modulation frequency across the electrode 2 and the electrode 3, and thus the polarization of the light 9 can be modulated.

As used in the present specification, controlling the polarization direction includes changing linearly polarized light to elliptically polarized light or to circular polarized light, keeping the polarization state of linearly polarized light while changing only the angle of polarization, and polarizing light in a prescribed direction. The control unit 5 controls the polarization direction of the light 9 such that the polarization state of the light 10 changes periodically, and thus the intensity of the terahertz wave 26 emitted from the generator 12 changes periodically. In other words, the control unit 5 controls the polarization direction of the light 9 such that the polarization direction of the light 10 incident on the generator 12 changes periodically, and thus the intensity of the terahertz wave 26 emitted from the generator 12 can be modulated.

When the crystal 4 is constituted by a crystal with a large nonlinear optical coefficient (electro-optic coefficient) r33, such as a Lithium Niobate (LiNbO₃) crystal and a KTP crystal, the polarization direction can be changed with high efficiency. The crystal 4 may also be constituted by a MgO-doped LiNbO₃ crystal so as to prevent optical damage. The types of crystal may be selected in consideration with the tolerance to the intensity of the light 9, the magnitude of a change in the polarization direction necessary for modulation, material dispersion in the wavelength range of the light 9, and so on. In addition, the thickness of the crystal 4 and the length of the crystal 4 in the direction in which the light 9 travels may be determined in consideration with the beam diameter of the light 9, the magnitude of a change in the polarization state necessary for modulation, an increase in the pulse duration of the light 9 caused by dispersion, and so on.

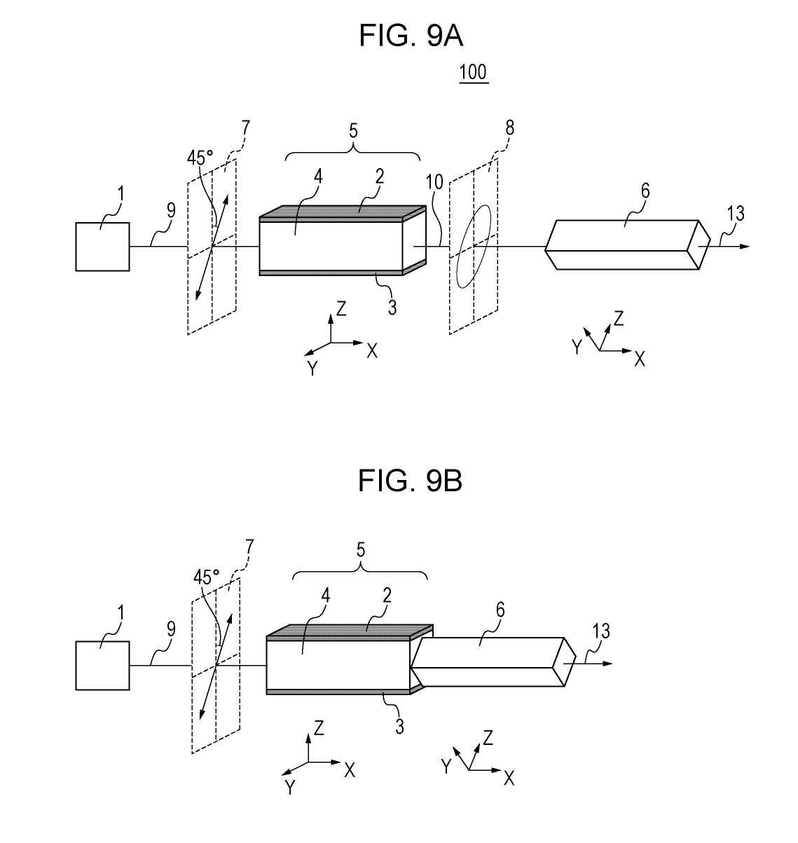

Hereinafter, the axial directions of the crystals 4 and 6 will be described. FIG. 9A is an illustration for describing the configuration of the device 100 and the axial directions of the crystals 4 and 6. In FIG. 9A, a detailed configuration of the generator 12 is omitted, and only the crystal 6 is illustrated for descriptive purpose. In order to use r33 at which the nonlinear optical coefficient serving as an index of the nonlinear optical effect is maximum, it is desirable that the electrode 2 and the electrode 3 be disposed along crystal planes that are orthogonal to a pyro axis (Z-axis) of the crystal 4.

As used in the present specification, the pyro axis is an axis extending in a direction in which the effective nonlinear optical constant of the nonlinear optical crystal is maximized. When the pyro axis coincides with the polarization direction of the light 10 incident on the crystal 6, the intensity of the terahertz wave 26 to be emitted from the generator 12 is maximized. In other words, the control unit 5 controls the polarization direction of the light 9 so as to change the electric-field intensity of the polarization of the light 10 in the direction of the pyro axis, and thus the intensity of the terahertz wave 26 is adjusted. In the present specification, the pyro axis is defined as the Z-axis of the crystal, and the axes that are orthogonal to the Z-axis (pyro axis) are defined as the X-axis and the Y-axis. This definition can be applied to the crystals 4 and 6 and later-described crystals 44 and 62.

It is desirable that the control unit 5 be disposed such that the polarization direction of the light 9 is at an angle of 45 degrees relative to the pyro axis of the crystal 4. When this angle is shifted, the extinction ratio (depth of modulation) in modulating the intensity of the terahertz wave 26 is reduced, and thus it is desirable that a shift in the angle, if any, be kept within ±5 degrees. When the crystal 4 is disposed in this manner, the control unit 5 can adjust the polarization with high efficiency. In addition, an anti-reflection film may be affixed to a face of the control unit 5 on which the light 9 is incident or from which the light 10 is emitted, and thus attenuation of the light 9 or 10 may be suppressed. It is desirable that the crystal 4 be disposed such that the direction in which the light 9 travels coincides with the X-axis of the crystal 4. In the present specification, the extinction ratio in modulating the intensity of the terahertz wave 26 is a ratio between a maximum value and a minimum value of the intensity of the terahertz wave 26 obtained when the terahertz wave 26 is modulated. Hereinafter, the stated extinction ratio may be referred to as simply the extinction ratio.

The modulation frequency of the voltage to be applied across the electrodes 2 and 3 for modulating the polarization of the light 9 needs to be set cautiously. Specifically, the stated modulation frequency needs to be set outside the structural resonant frequency of the crystal 4. When the control unit 5 that includes the crystal 4 is used, the modulation frequency can be adjusted typically within a range from DC to several hundred MHz, and that modulation frequency can greatly exceed several kHz or the upper limit of the modulation frequency obtained when an optical chopper is used. In addition, the device 100 makes it possible to modulate the intensity of the terahertz wave 26 through an electrical modulation method. Therefore, when the device 100 is used as a terahertz-wave generation source in a measurement apparatus, a change in a measurement result over time that arises due to an increase in noise or a positional shift in an optical system caused by vibration can be prevented.

An example of a measurement apparatus that includes the device 100 is a terahertz time domain spectroscopy (THz-TDS) apparatus that obtains a temporal waveform of a terahertz wave with the use of THz-TDS. With the configuration in which the polarization of the light 9 is controlled outside the light source 1 by using the control unit 5, the laser linewidth of the light 9 is less likely to fluctuate, and the long-term power stability is less likely to be deteriorated, as compared with a case in which a light source that outputs light whose polarization direction has been modulated is used.

In order to suppress an occurrence of a second harmonic wave, a lens (not illustrated) may be disposed between the light source 1 and the control unit 5 so as to adjust or increase the beam diameter of the light 9. In addition, in order to prevent the complex refractive index of the crystal 4 constituting the control unit 5 from fluctuating with temperature, the control unit 5 may be provided with a system, such as a thermostatic bath, for keeping its temperature constant.

The light 10, which has passed through the control unit 5 and has its polarization been adjusted, is incident on the crystal 6 in the generator 12 as elliptically polarized light having a polarization state 8 or as linearly polarized light (not illustrated). Upon the light 10 being incident on the crystal 6, a terahertz wave is emitted from the crystal 6. The intensity η of the terahertz wave emitted from the crystal 6 is expressed through Expression (1). In Expression (1), ω is the frequency of the emitted terahertz wave, d_{eff} is the second-order effective nonlinear optical constant, I is the intensity of the light 10, and ∈₀ is the dielectric constant in vacuum. In addition, n_{NIR} and n_{THz} are, respectively, the refractive index of the crystal 6 for the light 10 and the refractive index of the terahertz wave, c is the speed of light in vacuum, and α_{THz} is the absorption coefficient of the generated terahertz wave in the crystal 6.

$$η = \frac{8 {ω}^{2} {d}_{eff}^{2} I}{{ɛ}_{0} {n}_{NIR}^{2} {n}_{THz} {c}^{3} {α}_{THz}^{2}} \qquad ( 1 )$$

For example, when the crystal 6 is formed of LiNbO₃, the effective nonlinear optical constant in the direction of the pyro axis (Z-axis) is d₃₃=34.4 pm/V, which is greater than the effective nonlinear optical constants d₃₁=5.95 pm/V and d₂₂=3.07 pm/V in other axial directions. Therefore, the intensity η of the generated terahertz wave is determined substantially by a component of the light 10 in the direction that coincides with the pyro axis. Accordingly, as the control unit 5 adjusts the polarization state of the light 10 so as to adjust a component of the light 10 in the direction that coincides with the pyro axis of the crystal 6, the intensity of the terahertz wave to be generated can be adjusted.

A photoconductive element that is often used to generate a terahertz wave is less sensitive to the polarization direction of light incident on the photoconductive element than is a nonlinear optical crystal. Thus, in order to modulate light, a polarizer needs to be disposed between a polarization control unit and the photoconductive element so as to adjust the intensity of the light. Therefore, the power of the terahertz wave may be attenuated due to an influence of reflection, absorption, or dispersion by the polarizer, or the bandwidth of the terahertz wave may be reduced. However, when the generator 12 is used as a terahertz-wave generation unit, the intensity of the terahertz wave to be emitted from the crystal 6 largely depends on the polarization direction of the light 9 (primarily the component in the direction of the pyro axis or the Z-axis). Therefore, the intensity of the terahertz wave can be adjusted only by adjusting the electric-field intensity of the polarization component of the light 9 in the direction of the Z-axis (electric-field intensity in the direction of the Z-axis). In other words, a polarizer does not need to be used, and thus an influence of reflection, absorption, and dispersion of the terahertz wave by the polarizer can be eliminated.

In order to maximize the output of the terahertz wave generated while a voltage is not applied across the electrode 2 and the electrode 3, it is desirable that the pyro axis of the crystal 6 in the generator 12 coincide with the polarization direction of the light 9 incident on the crystal 4. In addition, in order to maximize the output of the terahertz wave generated while a voltage is applied across the electrode 2 and the electrode 3, it is desirable that the pyro axis of the crystal 6 be orthogonal to the polarization direction of the light 9.

Furthermore, it is desirable that the polarization state of the light 10, which has passed through the control unit 5, can be adjusted to the polarization state 8 of the elliptically polarized light from the polarization state held prior to passing through the control unit 5 and then to linearly polarized light polarized at an angle of 90 degrees relative to the polarization direction of the light 9. The polarization direction of the light 9 can be changed as desired by adjusting the length of the crystal 4, the distance between the electrode 2 and the electrode 3, and the magnitude of the voltage applied across the electrode 2 and the electrode 3. For example, when the crystal 6 is formed of LiNbO₃, by changing the polarization direction in the polarization state 7 by 90 degrees, the terahertz wave to be emitted from the crystal 6 can be subjected to the intensity modulation with a large amplitude at an extinction ratio of approximately 100:1.

In FIG. 9A, the control unit 5 and the generator 12 are spaced apart from each other. Alternatively, as illustrated in FIG. 9B, the control unit 5 and the generator 12 may be disposed so as to be in contact with each other. In that case, the control unit 5 and the generator 12 may be directly integrated by bonding the control unit 5 and the generator 12 with an adhesive or the like, or the control unit 5 and the generator 12 may be integrated on a substrate. Having been integrated, the control unit 5 and the generator 12 are less likely to experience a position shift therebetween over time, and the terahertz wave 26 that is adjusted to have a desired intensity can stably be obtained.

The crystal 6 according to the present exemplary embodiment is formed of a LiNbO₃ crystal. Alternatively, other nonlinear optical crystals, such as Lithium Tantalate (LiTaO₃), Niobium Tantalate (NbTaO₃), Potassium titanyl phosphate (KTP), Diethylaminosulfur trifluoride (DAST), Zinc Telluride (ZnTe), Gallium Selenide (GaSe), and Gallium Arsenide (GaAs), may also be used. In addition, the generator 12 that includes the crystal 6 of a bulk shape can be employed, or the generator 12 that includes a waveguide and is processed into an optical waveguide shape may be used. When the generator 12 of an optical waveguide shape is used, the control unit 5 and the generator 12 may be aligned precisely and be integrated.

The direction in which the terahertz wave emitted from the crystal 6 travels coincides with the direction in which the light 10 travels when the terahertz wave is generated through the difference frequency generation, or coincides with the direction that satisfies the phase matching condition when the terahertz wave is generated through optical rectification. The generated terahertz wave can be extracted with increased efficiency when a silicon prism, serving as a coupling member for extracting the generated terahertz wave into a space, is attached to a face (emission face) of the crystal 6 from which the terahertz wave is emitted. The emission face is often set to a face of the crystal 6 that is substantially perpendicular to the X-axis or the Y-axis, excluding the pyro axis, of the crystal 6. When the generator 12 has an optical waveguide shape, the dimensions of the waveguide 201 may be adjusted so as to form a waveguide provided with a function of a polarizer. Specifically, the waveguide 201 can be provided with a function of a polarizer by adjusting the size of the waveguide 201 such that the propagation in a TM mode is suppressed and only the propagation in a TE mode occurs. In that case, the above-described extinction ratio in modulating the intensity of the terahertz wave can be increased.

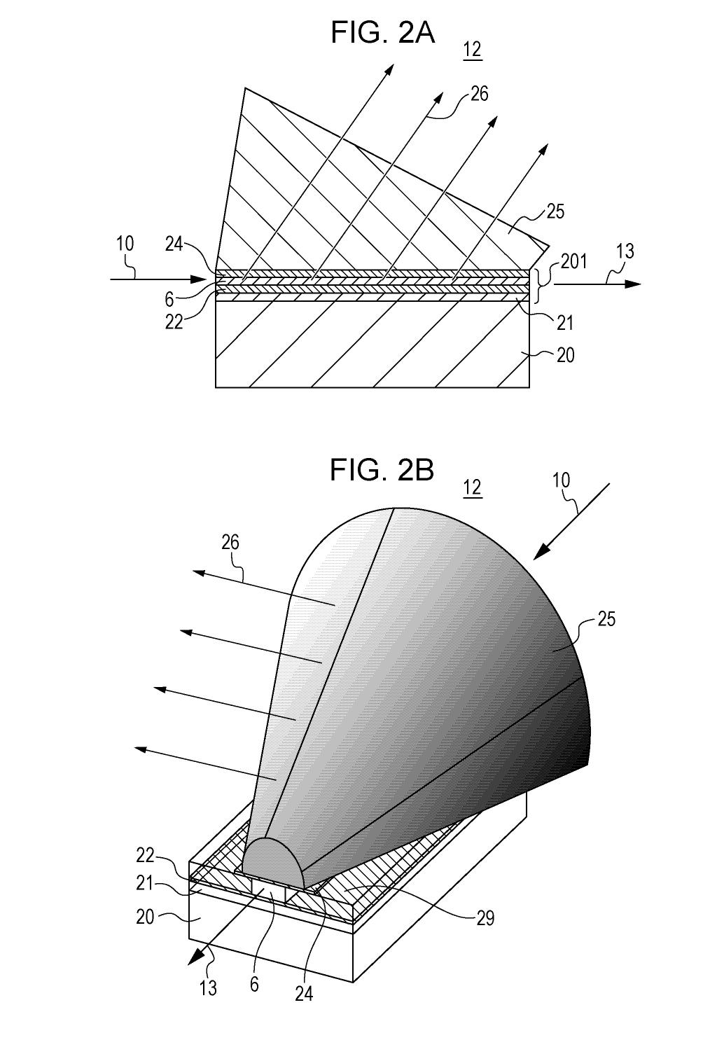

FIG. 2A is a sectional view of the generator 12 taken along the lengthwise direction of the waveguide 201, and FIG. 2B is a perspective view of the generator 12. The generator 12 includes a substrate 20, the waveguide 201, and the coupling member 25. With the generator 12, the terahertz wave 26 emitted from the crystal 6 is radiated through Cherenkov radiation (hereinafter, referred to as the Cherenkov radiation), and the radiated terahertz wave 26 is extracted to the outside of the waveguide 201 through the coupling member 25. The Cherenkov radiation is a phenomenon in which the generated terahertz wave 26 is radiated in a conical shape as in a shock wave, and occurs when the propagation group velocity V_{g} of the light 10 that propagates through the crystal 6 is greater than the propagation phase velocity V_{THz} of the terahertz wave 26 that propagates through the crystal 6.

It is to be noted that it may suffice if the waveguide 201 includes at least an upper clad layer 24 and a lower clad layer 22. The refractive indices of the upper clad layer 24 and the lower clad layer 22 for the wavelength of the terahertz wave 26 are less than the refractive index of the crystal 6 for the wavelength of the terahertz wave 26.

The substrate 20 is a Y-cut LiNbO₃ substrate and is disposed such that the X-axis of LiNbO₃ extends in the direction in which the light 10 travels and the Z-axis of LiNbO₃ extends in the direction that is orthogonal to the direction in which the light 10 travels and that is parallel to the substrate 20. Through such a configuration, when the light 10 having an electric field component that is parallel to the Z-axis is incident on the crystal 6, the terahertz wave can be extracted with high efficiency through the Cherenkov radiation, which is a second-order nonlinear phenomenon.

The waveguide 201 is provided on the substrate 20 for propagating the light 10. The waveguide 201 includes the crystal 6, an adhesion layer 21, the lower clad layer 22, and the upper clad layer 24. The crystal 6 is a waveguide layer containing MgO-doped LiNbO₃. The adhesion layer 21 for sticking dissimilar substrates is provided between the lower clad layer 22 and the substrate 20, but the adhesion layer 21 may also serve as the lower clad layer. It is to be noted that the adhesion layer 21 is necessary in a case in which the waveguide 201 is fabricated by sticking the lower clad layer 22 and the substrate 20 together, and is not necessarily required in a case in which a doped layer is formed through diffusion or the like. In such a case, the refractive index of the substrate 20 is greater than the refractive index of the MgO-doped LiNbO₃ layer, and thus the substrate 20 functions as the lower clad layer so as to form the waveguide 201.

The upper clad layer 24 can be suitably constituted by a thin film of SiOx, SiNx, or the like or a resin having a refractive index smaller than the refractive index of LiNbO₃ serving as the crystal 6. The coupling member 25 is provided on the waveguide 201 for extracting the generated terahertz wave to the outside. The upper clad layer 24 may also serve as an adhesive for bonding the coupling member 25 to the crystal 6.

The waveguide 201 may have a structure in which, after the width of the crystal 6 in the lateral direction has been reduced through a method in which a refractive index difference between the crystal 6 and a surrounding region 29 is produced by increasing the refractive index of the crystal 6 by Ti diffusion, or through an etching method, the crystal 6 is protected by a surrounding SiOx film, resin, or the like. The waveguide 201 according to the present exemplary embodiment is a ridge-shaped waveguide in which the width of the crystal 6 in the lateral direction is shorter than the wavelength of the terahertz wave to be generated. Although a waveguide structure is also formed in the lateral direction in order to confine more light in the present exemplary embodiment, a slab waveguide (not illustrated) that does not include a confinement region and in which the waveguide layer (crystal 6) extends uniformly in the lateral direction may also be used. In addition, instead of different clad layers being provided around the crystal 6, the clad layers on the four sides of the crystal 6 may be integrally formed.

When the light 10 having a polarization component that is parallel to the Z-axis of the crystal 6 is incident on the crystal 6 and propagates through the crystal 6 along the X-axis, the generation efficiency of the terahertz wave to be generated through optical rectification is maximized. The terahertz wave 26 emitted from the crystal 6 is extracted into the space through the coupling member 25. The coupling member 25 is disposed on the waveguide 201 and is a member for extracting the terahertz wave 26 to the outside. The coupling member 25 may be formed by a prism, a diffraction grating, a photonic crystal, or the like.

It is desirable that the upper clad layer 24 be thick enough for the upper clad layer 24 to function as a clad layer when the light 10 propagates through the crystal 6 and be thin enough that the influence of multi-reflection or a loss caused when the terahertz wave 26 is extracted to the outside through the coupling member 25 can be ignored.

Specifically, it is sufficient if the optical intensity at the interface between the upper clad layer 24 and the coupling member 25 is no more than 1/e² of the optical intensity in the crystal 6 when some of the light 10 propagating through the crystal 6 leaks to the upper clad layer 24. In addition, it is desirable that the thickness of the upper clad layer 24 be set to no more than approximately 1/10 of an equivalent wavelength, in the upper clad layer 24, of a terahertz wave having the highest frequency among the terahertz wave 26 with a frequency that is to be extracted to the outside. This is because, typically, if the thickness of a structural body is approximately 1/10 of the wavelength of the electromagnetic wave, an influence of reflection, scattering, refraction, or the like on that electromagnetic wave can be ignored.

However, it is possible to generate the terahertz wave 26 even when the thickness of the upper clad layer 24 is outside the above-described thickness range. The upper clad layer 24 can be formed of a resin, such as PET, or a dielectric material, such as SiOx and SiNx. In addition, it is desirable that the thickness of the lower clad layer 22 also satisfy a condition similar to the condition for the thickness of the upper clad layer 24 so that the lower clad layer 22 functions as a clad layer for the light 10.

An angle θ_{c} formed by the direction in which the terahertz wave 26 travels and the direction in which the light 10 propagating through the crystal 6 travels (hereinafter, referred to as the Cherenkov radiation angle) can be expressed through Expression (2). In Expression (2), n_{g} is the group index of the crystal 6 for the light 10, and n_{THz} is the refractive index of the crystal 6 for the terahertz wave 26.

cos θ_{c}=n_{g}/n_{THz} (2)

In the present exemplary embodiment, the crystal 6 is formed of LiNbO₃, and the coupling member 25 is formed of a high-resistance silicon (Si). Therefore, the Cherenkov radiation angle in the waveguide 201 is approximately 65 degrees. In addition, the terahertz wave 26 is refracted when being incident on the coupling member 25 from the waveguide 201, and thus the Cherenkov radiation angle θ_{clad} in the coupling member 25 is approximately 49 degrees.

The crystal 6 that is formed of a LiNbO₃ crystal is birefringent, and thus when the polarization direction of the light 10 for generating the terahertz wave 26 changes from the direction of the Z-axis of the crystal 6, the refractive index for the light 10 changes accordingly. Therefore, as indicated by Expression (2), the Cherenkov radiation angle θ_{c} also changes in accordance with the polarization direction of the light 10. The configuration in which the waveguide 201 is provided as in the present exemplary embodiment makes it possible to change the position that the terahertz wave 26 reaches with a change in the Cherenkov radiation angle θ_{c}, and thus the quantity of the terahertz wave 26 that is incident on the detection unit that detects the terahertz wave 26 changes. Therefore, in addition to modulating the intensity of the terahertz wave 26 to be generated in accordance with the polarization direction of the light 10 and the nonlinear optical constant that differs for each crystal orientation, the intensity can also be modulated in the detection unit in accordance with a change in the Cherenkov radiation angle θ_{c} of the terahertz wave 26. In particular, when the detection unit is constituted by a position-sensitive photoconductive element, the intensity of the terahertz wave 26 to be detected can be changed greatly.

When the upper clad layer 24 in the waveguide 201 is sufficiently thin relative to the wavelength of the terahertz wave (no more than 1/20 of the wavelength of the terahertz wave), it may be difficult to define the Cherenkov radiation angle. However, even in such a case, the Cherenkov radiation angle θ_{clad} in the coupling member 25 can be calculated from the refractive index of the coupling member 25 and the refractive index of the crystal 6.

The waveguide 201 according to the present exemplary embodiment is ridge-shaped, and thus the terahertz wave 26 becomes divergent in the direction orthogonal to the direction in which the light 10 travels. In the meantime, a component of the terahertz wave 26 in the direction parallel (parallel direction) to the direction in which the light 10 travels hardly diverges. Therefore, as illustrated in FIG. 2B, the coupling member 25 has a shape of a truncated cone so that the coupling member 25 has a converging function only in one direction.

Although the crystal 6 is constituted by a LiNbO₃ crystal, the crystal 6 can also be constituted by a different nonlinear optical crystal, as described above. In that case, although the refractive index of LiNbO₃ differs for the terahertz wave 26 and for the light 10 and the terahertz wave 26 generated noncollinearly can be extracted, the difference in the refractive index is not large when a different crystal is used, and it may thus be difficult to extract the terahertz wave 26. However, if the terahertz-wave generation unit that includes a waveguide and a prism are proximal to each other, the condition for the Cherenkov radiation (V_{THz}<V_{g}) can be satisfied when a prism (e.g., Si) having a refractive index that is greater than the refractive index of a nonlinear optical crystal is used, and thus the terahertz wave 26 can be extracted to the outside.

It is to be noted that, even if the waveguide 201 is not provided, the terahertz wave to be generated can be modulated by controlling the polarization direction of the light 9. In addition, the present exemplary embodiment can be applied to a method in which the pulse front of the light 10 is tilted for phase matching and a terahertz wave is generated, or to a parametric generation method in which light with two different frequencies is used.

Thus far, the configuration of the device 100 has been described. According to the device 100, the polarization of the light 10 to be incident on the generator 12 is modulated by using the control unit 5, and thus the intensity of the terahertz wave 26 to be generated is modulated. Specifically, the control unit 5 subjects the light 9 to high-speed polarization modulation of up to several hundred MHz to obtain the light 10, and the obtained light 10 is incident on the generator 12. Therefore, the modulation range is broad, and the terahertz wave 26 whose intensity has been modulated stably can be obtained.

In addition, when the polarization state of the light 10 is controlled, the output of the terahertz wave 26 can be adjusted accordingly. Therefore, the terahertz wave 26 can be supplied stably for an extended period of time. Furthermore, since the waveguide 201 is provided, the Cherenkov radiation angle can be changed in accordance with the polarization direction of the light 10. Therefore, in the case in which the terahertz wave 26 is detected, the intensity can also be modulated in accordance with the position on the detection unit on which the terahertz wave 26 is incident, and the intensity modulation range can be further broadened.

### Second Exemplary Embodiment

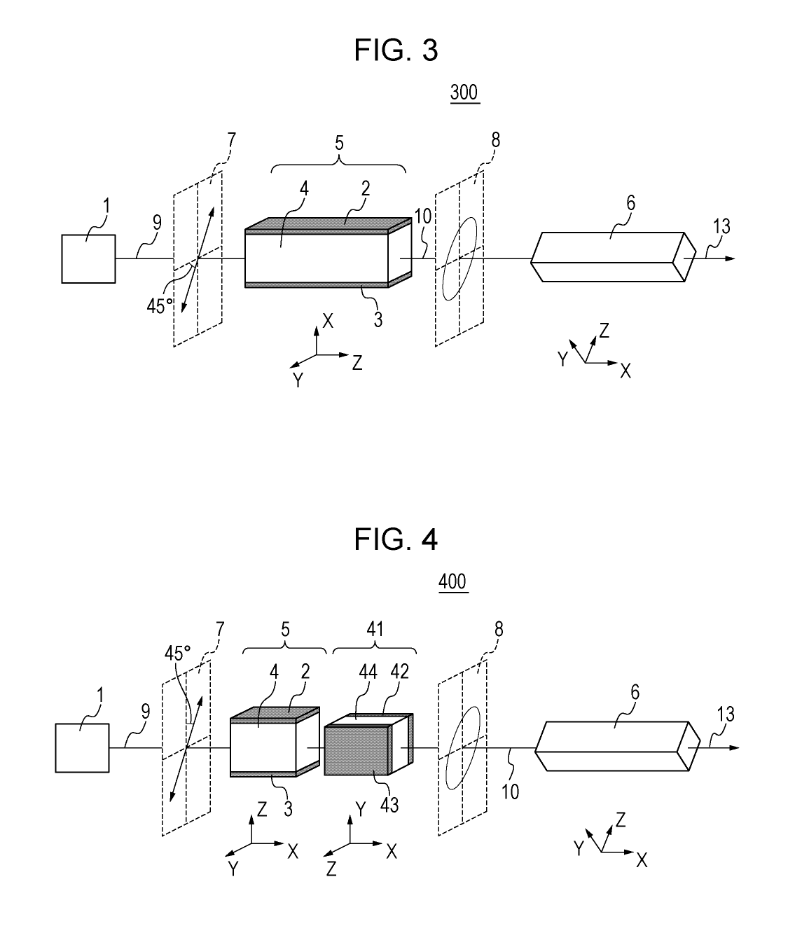

A terahertz-wave generation device 300 (hereinafter, referred to as the device 300) according to the present exemplary embodiment will be described with reference to FIG. 3. FIG. 3 is an illustration for describing the configuration of the device 300 and the axial directions of the crystals 4 and 6. In FIG. 3, the waveguide 201 and the coupling member 25 in the generator 12 are omitted, and only the crystal 6 is illustrated for descriptive purpose. In the device 300, the control unit 5 is disposed such that the pyro axis of the crystal 4 in the control unit 5 coincides with the direction in which the light 9 travels, and the electrode 2 and the electrode 3 are disposed along the crystal planes that are orthogonal to the X-axis of the crystal 4. Other configurations of the device 300 are the same as those of the device 100 according to the first exemplary embodiment, and thus descriptions thereof will be omitted.

In the device 300, the direction in which the light 9 travels coincides with the pyro axis, which is the optical axis (axis about which the refractive indices are rotationally symmetric) of the crystal 4. The electrode 2 and the electrode 3 may be provided along the crystal planes orthogonal to the Y-axis of the crystal 4. In other words, the control unit 5 is disposed such that the polarization direction of the light 9 is at an angle of 45±5 degrees relative to the X-axis or the Y-axis. Through this configuration, the polarization can be modulated with high efficiency.

The effective nonlinear optical constant of the crystal 4 in this case is smaller than the effective nonlinear optical constant in the case of the first exemplary embodiment, and thus the length (crystal length) I of the crystal 4 in the direction of its pyro axis is increased. Thus, the intensity of the terahertz wave 26 can be modulated at a level equivalent to the level in the first exemplary embodiment. The magnitude Δφ of a phase shift given by the crystal 4 can be expressed through Expression (3). Thus, the crystal length I needs to be increased by an amount by which the effective nonlinear optical constant r of the crystal 4 has decreased. In Expression (3), V is a voltage applied across the electrodes 2 and 3, λ is the wavelength of the light 9, and d is the distance between the electrode 2 and the electrode 3.

$$Δφ = \frac{π {n}_{0}^{3} rV}{λ} \cdot \frac{l}{d} \qquad ( 3 )$$

According to the device 300, the control unit 5 subjects the light 9 to high-speed polarization modulation of up to several hundred MHz to obtain the light 10, and the obtained light 10 is incident on the crystal 6 in the generator 12. Therefore, the modulation range is broad, and the terahertz wave 26 whose intensity has been modulated stably can be obtained. In addition, when the polarization state of the light 10 is controlled, the output of the terahertz wave 26 can be adjusted accordingly. Therefore, the terahertz wave 26 can be supplied stably for an extended period of time. Furthermore, since the waveguide 201 is provided, the Cherenkov radiation angle can be changed in accordance with the polarization direction of the light 10. Therefore, in the case in which the terahertz wave 26 is detected, the intensity can also be modulated in accordance with the position on the detection unit on which the terahertz wave 26 is incident, and the intensity modulation range can be further broadened.

Furthermore, as described above, since the control unit 5 is disposed such that the direction in which the light 9 travels coincides with the pyro axis of the crystal 4, an influence of an increase in the pulse duration of the light 10 caused by birefringence in the crystal 4 or a change in the refractive index with temperature can be suppressed.

### Third Exemplary Embodiment

A configuration of a terahertz-wave generation device 400 (hereinafter, referred to as the device 400) according to a third exemplary embodiment will be described with reference to FIG. 4. FIG. 4 is an illustration for describing the configuration of the device 400 and the axial directions of crystals 4, 6, and 44. In FIG. 4, the waveguide 201 and the coupling member 25 in the generator 12 are omitted, and only the crystal 6 is illustrated for descriptive purpose. The device 400 includes, in addition to the components of the device 100 according to the first exemplary embodiment, a polarization control unit 41 (hereinafter, referred to as the control unit 41) that has a shape similar to the shape of the control unit 5. The control unit 41 includes electrodes 42 and 43 and a nonlinear optical crystal 44 (hereinafter, referred to as the crystal 44), and the crystal 44 is disposed between the electrode 42 and the electrode 43. Other configurations of the device 400 are the same as those of the device 100 according to the first exemplary embodiment, and thus descriptions thereof will be omitted.

The control unit 41 is disposed such that the pyro axis of the crystal 44 is at an angle of 90±5 degrees relative to the pyro axis of the crystal 4. The length of the crystal 4 in the direction in which the light 9 travels is the same as the length of the crystal 44 in the direction in which the light 9 travels. In addition, it is desirable that the control units 5 and 41 can adjust the polarization state of the light 10 to be incident on the generator 12 to the state of elliptically polarized light as in the polarization state 8 from the polarization state 7 held prior to passing through the control unit 5 and then to linearly polarized light polarized in the direction that is at an angle of 90 degrees relative to the polarization direction of the light 9.

According to the device 400, the control units 5 and 41 subject the light 9 to high-speed polarization modulation of up to several hundred MHz to obtain the light 10, and the obtained light 10 is incident on the generator 12. Therefore, the modulation range is broad, and the terahertz wave 26 whose intensity has been modulated stably can be obtained. In addition, when the polarization state of the light 10 is controlled, the output of the terahertz wave 26 can be adjusted accordingly. Therefore, the terahertz wave 26 can be supplied stably for an extended period of time. Furthermore, since the waveguide 201 is provided, the Cherenkov radiation angle can be changed in accordance with the polarization direction of the light 10. Therefore, in the case in which the terahertz wave 26 is detected, the intensity can be modulated in accordance with the position on the detection unit on which the terahertz wave 26 is incident, and the intensity modulation range can be further broadened.

The two control units 5 and 41 are disposed such that the pyro axis of the crystal 4 is orthogonal to the pyro axis of the crystal 44, and thus the polarization component of the light 9 travels the same optical path length in a refractive index region in the directions of the pyro axis of the crystal 4 and the pyro axis of the crystal 44 and in a refractive index region in the direction of the Y-axis. Accordingly, polarization modulation that is not dependent on temperature and that is free from birefringence can be achieved.

### Fourth Exemplary Embodiment

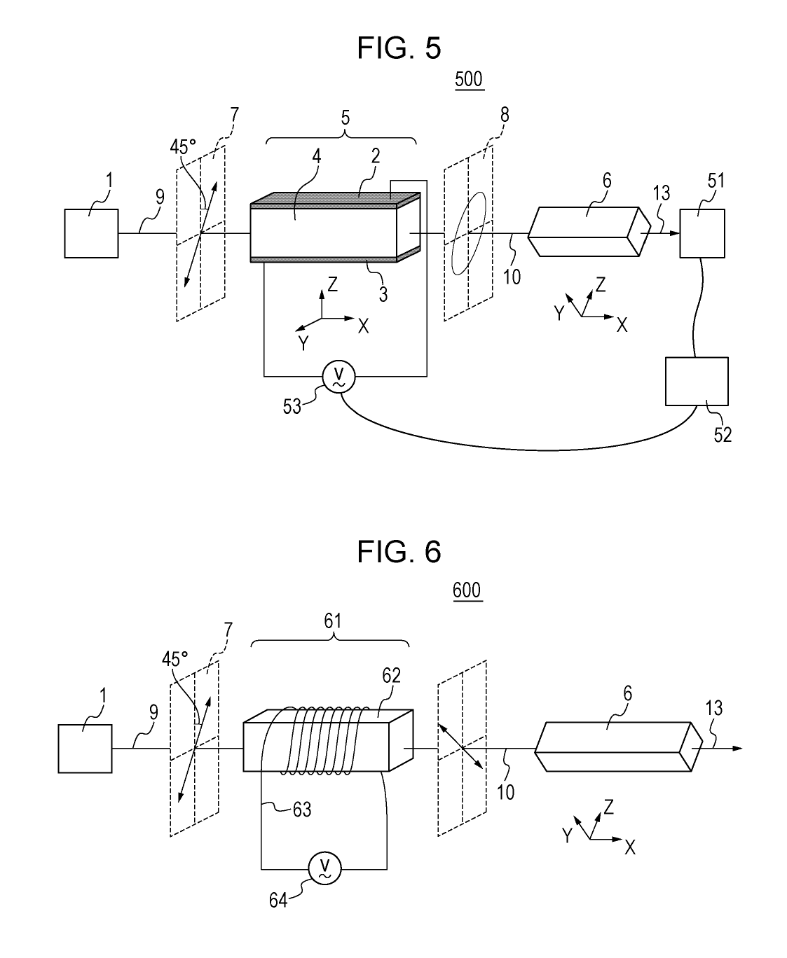

A configuration of a terahertz-wave generation device 500 (hereinafter, referred to as the device 500) according to a fourth exemplary embodiment will be described with reference to FIG. 5. FIG. 5 is an illustration for describing the configuration of the device 500 and the axial directions of the crystals 4 and 6. In FIG. 5, the waveguide 201 and the coupling member 25 in the generator 12 are omitted, and only the crystal 6 is illustrated for descriptive purpose. The device 500 includes, in addition to the components of the first exemplary embodiment, an optical detection unit 51 and a controller 52. Descriptions of the configurations that are similar to those of the first exemplary embodiment will be omitted.

The optical detection unit 51 detects the intensity of light 13 emitted from the crystal 6 in the generator 12. The optical detection unit 51 may be constituted by a photodiode, a pyroelectric detector, or the like. The intensity of the light 13 detected by the optical detection unit 51 is monitored by the controller 52 constituted by a personal computer (PC) or the like. The controller 52 controls the voltage, generated by a power supply 53, to be applied across the electrodes 2 and 3 on the basis of the result of detection by the optical detection unit 51. In this case, the controller 52 adjusts the voltage generated by the power supply 53 so that the intensity of the light 13 stays constant. In addition, the controller 52 can make an adjustment on the basis of the result of detection by the optical detection unit 51 so that the maximum intensity of the terahertz wave whose intensity has been modulated stays constant.

The intensity of the terahertz wave emitted from the generator 12 increases as the intensity of the light 10 incident on the crystal 6 in the generator 12 is greater, as described above. The light utilization efficiency of the generator 12 hardly changes, and thus the intensity of the light 13 reflects the intensity of the terahertz wave 26 emitted from the generator 12. In other words, according to the device 500, even if the light source 1, the control unit 5, or the generator 12 deteriorates over time or experiences a change in the characteristics due to a change in the temperature, an influence of such deterioration and change can be suppressed, and the terahertz wave 26 can be obtained stably.

The voltage generated by the power supply 53 may be adjusted such that the terahertz wave 26 of a somewhat lower output than the terahertz wave 26 of the maximum output that can be emitted from the generator 12 is outputted, and an adjustable range may be secured so as to accommodate a change in the light source 1, the control unit 5, or the generator 12. A polarizer (not illustrated) may be disposed between the generator 12 and the optical detection unit 51. In this case, the polarizer extracts only a light beam of the light 13 in the direction of the pyro axis (component in the direction of the pyro axis) and only the component of the light 13 in the direction of the pyro axis of the crystal 6 reaches the optical detection unit 51. With such a configuration, not only the deterioration of the light source 1, the control unit 5, or the generator 12 that arises over time or a change in the characteristics arising due to a change in the temperature but also a change in the polarization state or in the characteristics of the component in the direction of the pyro axis can be monitored.

It is to be noted that a portion of the terahertz wave 26 emitted from the crystal 6 may be detected, and the control unit 5 may control the polarization direction of the light 9 from the light source 1 on the basis of the detection result. In this case, since a portion of the terahertz wave 26 is removed, the intensity of the terahertz wave 26 that can be used for a measurement or the like decreases. In addition, an optical component needs to be disposed in a propagation path of the terahertz wave 26 in order to extract a portion of the terahertz wave 26, and thus the pulse waveform may change due to an influence of dispersion or absorption by the optical component. Therefore, it is desirable that the light 13 be detected.

According to the device 500, the control unit 5 subjects the light 9 to high-speed polarization modulation of up to several hundred MHz to obtain the light 10, and the obtained light 10 is incident on the generator 12. Therefore, the modulation range in broad, and the terahertz wave 26 whose intensity has been modulated stably can be obtained. In addition, when the polarization state of the light 10 is controlled, the output of the terahertz wave 26 can be adjusted accordingly. Therefore, the terahertz wave 26 can be supplied stably for an extended period of time. Furthermore, since the waveguide 201 is provided, the Cherenkov radiation angle can be changed in accordance with the polarization direction of the light 10. Therefore, in the case in which the terahertz wave 26 is detected, the intensity can be modulated in accordance with the position on the detection unit on which the terahertz wave 26 is incident, and the intensity modulation range can be further broadened.

Furthermore, the light 13 emitted from the crystal 6 is detected, and the voltage applied to the control unit 5 is controlled on the basis of the detection result. Therefore, the polarization of the light can be controlled with high precision.

### Fifth Exemplary Embodiment

A configuration of a terahertz-wave generation device 600 (hereinafter, referred to as the device 600) according to a fifth exemplary embodiment will be described with reference to FIG. 6. FIG. 6 is an illustration for describing the configuration of the device 600 and the axial direction of the crystal 6. In FIG. 6, the waveguide 201 and the coupling member 25 in the generator 12 are omitted, and only the crystal 6 is illustrated for descriptive purpose. The device 600 includes a polarization control unit 61 (hereinafter, referred to as the control unit 61) that includes a Faraday cell, in place of the control unit 5 of the first exemplary embodiment. Descriptions of the configurations that are similar to those of the first exemplary embodiment will be omitted.

The Faraday cell rotates the plane of polarization of linearly polarized light through a magneto-optical effect (the Faraday effect) by which the polarization state of light rotates through a magnetic field. The control unit 61 includes a magnetic member 62 and a coil 63 that is wound around the magnetic member 62. A power supply 64 applies a voltage to the coil 63 so as to generate a magnetic field in the direction that coincides with the direction in which the light 9 travels, and thus the polarization direction of the light 9 can be controlled through the Faraday effect. In other words, upon the linearly polarized light 9 being incident on the control unit 61, the control unit 61 changes the polarization direction of the linearly polarized light 9 while retaining its polarization state. Through this configuration, the electric-field intensity in the direction of the pyro axis (Z-axis) of the light 10 to be incident on the generator 12 is controlled.

The rotation angle θ of the polarization state of the light through the Faraday effect is expressed through Expression (4), in which H is the strength of the magnetic field and I is the length of the magnetic member through which the polarized light passes.

θ=VHI (4)

V in Expression (4) is a Verdet constant, which is dependent on the type of the substance, the wavelength of the polarized light, and the temperature. The magnetic member 62 is typically formed of a material having a large Verdet constant V, or in other words, having a large Faraday effect. Examples of such a material includes bismuth iron garnet (BIG) and yttrium iron garnet (YIG). Another example is gadolinium gallium garnet (GGG).

It is desirable that the control unit 61 can adjust the polarization state of the light 10 to be incident on the generator 12 to a state of linearly polarized light that is polarized in the direction at an angle of 90 degrees relative to the polarization direction (polarization state 7) of the light 9. The range in which the polarization is controlled can be adjusted by the length of the magnetic member 62 and the strength of the magnetic field applied through the coil 63 and so on. When the crystal 6 is constituted by a LiNbO₃ crystal, by changing the polarization direction in the polarization state 7 by 90 degrees, the terahertz wave emitted from the generator 12 can be subjected to intensity modulation with a large modulation amplitude at an extinction ratio of approximately 100:1, as in the first exemplary embodiment.

When the control unit 61 that includes the Faraday cell is used, the modulation frequency can be adjusted typically within a range from DC to several tens of kHz, and that modulation frequency can greatly exceed several kHz or the upper limit of the modulation frequency obtained when an optical chopper is used. In addition, since the method is an electrical modulation method, a change in the data over time arising due to an increase in noise in the measurement data or a positional shift in the measurement system caused by vibration can be prevented.

According to the device 600 of the present exemplary embodiment, the polarization of the light 10 to be incident on the generator 12 is modulated by using the control unit 61, and thus the intensity of the terahertz wave 26 to be generated is modulated. Specifically, the control unit 61 subjects the light 9 to high-speed polarization modulation of up to several hundred MHz to obtain the light 10, and the obtained light 10 is incident on the crystal 6 in the generator 12. Therefore, the modulation range is broad, and the terahertz wave 26 whose intensity has been modulated stably can be obtained.

In addition, when the polarization state of the light 10 is controlled, the intensity of the terahertz wave 26 can be adjusted accordingly. Therefore, the terahertz wave 26 can be supplied stably for an extended period of time. Furthermore, since the waveguide 201 is provided, the Cherenkov radiation angle can be changed in accordance with the polarization direction of the light 10. Therefore, in the case in which the terahertz wave 26 is detected, the intensity can be modulated in accordance with the position on the detection unit on which the terahertz wave 26 is incident, and the intensity modulation range can be further broadened.

Furthermore, since the polarization of the light 9 that has been outputted from the light source 1 is controlled, the polarization can be modulated without a fluctuation in the generated laser linewidth or a drop in the long-term power stability, as compared with a case in which the light source 1 directly outputs modulated light.

### Sixth Exemplary Embodiment

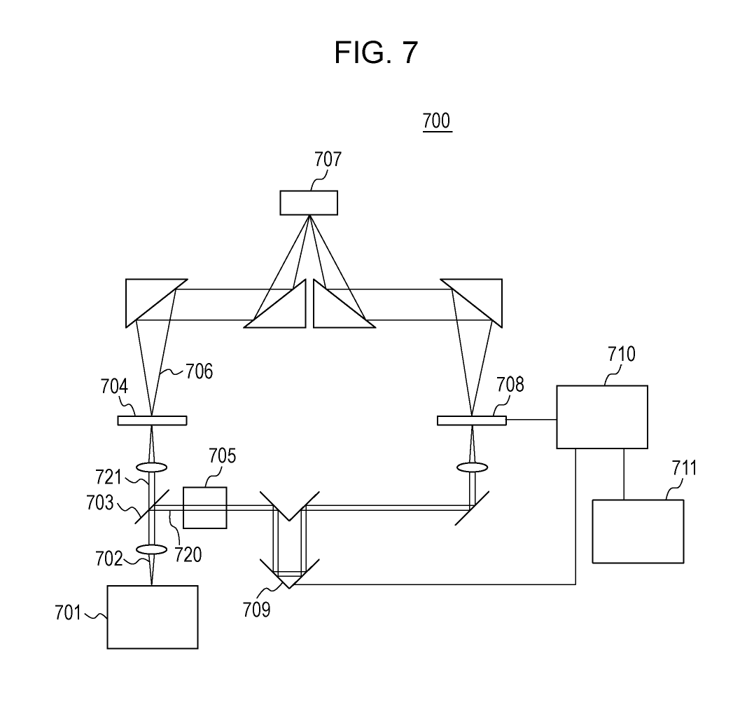

The present exemplary embodiment relates to a measurement apparatus 700 (hereinafter, referred to as the apparatus 700) that includes the device 100 according to the first exemplary embodiment. The configuration of the apparatus 700 will be described with reference to FIG. 7. FIG. 7 illustrates the configuration of the apparatus 700. The apparatus 700 is a THz-TDS apparatus that obtains a temporal waveform of a terahertz wave through THz-TDS.

A light source 701 outputs pulsed light 702 (hereinafter, referred to as the light 702). The light source 701 may be constituted by a fiber laser or the like. In the present exemplary embodiment, the light 702 is ultrashort pulsed laser light at a wavelength in a 1.5-μm band and with a pulse duration (full width at half maximum expressed in power) of approximately 30 fs. The light 702 is split into probe light 720 and pumping light 721 by a beam splitter 703. The probe light 720 is incident on a second harmonic wave generation unit 705, and the pumping light 721 is incident on a generation unit 704.

The generation unit 704 is constituted by a terahertz-wave generation device such as those described in the exemplary embodiments above. The pumping light 721 is shaped to have a shape suitable for the terahertz-wave generator 12 of the generation unit 704 by being converged by a lens and reaches the generation unit 704. Upon the pumping light 721 reaching the generation unit 704, a terahertz-wave pulse 706 (hereinafter, referred to as the terahertz wave 706″ is emitted from the generation unit 704. The terahertz wave 706 can be extracted efficiently when the terahertz wave 706 is extracted to the outside from the crystal 6 through a silicon prism included in the generator 12. According to the configuration described above, the terahertz wave 706 with a pulse duration (full width at half maximum) in a range from several hundred fs to several ps can be radiated.

The terahertz wave 706 radiated into the space is guided to a sample 707 by optical elements, such as a lens and a mirror. The terahertz wave 706 reflected by the sample 707 is incident on a detection unit 708 via optical elements.

The probe light 720 incident on the second harmonic wave generation unit 705 becomes pulsed laser light at a wavelength in a 0.8-μm band through a second harmonic wave conversion process. The second harmonic wave generation unit 705 includes a second harmonic wave generation element that may be constituted by a periodically poled lithium niobate (PPLN) crystal or the like. Light at a wavelength generated through another nonlinear process or light at a wavelength in a 1.5-μm band emitted without having its wavelength being converted is removed from the probe light 720 by a dichroic mirror or the like (not illustrated). The probe light 720 whose wavelength has been converted into a 0.8-μm band passes through a delay unit 709 and is then incident on the detection unit 708.

The detection unit 708 detects the terahertz wave 706 from the sample 707 and is typically constituted by a photoconductive element. However, a different, well-known terahertz wave detector can also be used. The detection unit 708 detects the terahertz wave 706 when the terahertz wave 706 from the sample 707 and the probe light 720 are incident on the detection unit 708. Although the configuration is such that the probe light 720 whose wavelength has been converted to a wavelength in a 0.8-μm band by the second harmonic wave generation unit 705 is incident on the detection unit 708, the probe light 720 at a wavelength in a 1.5-μm band that has not been subjected to wavelength conversion can also be detected. Photoexcited carriers generated in a photoconductive layer in the photoconductive element are accelerated by the electric field of the terahertz wave 706, and a current is generated between the electrodes. The value of this current reflects the electric-field intensity of the terahertz wave 706 in a time period in which a photoelectric current flows. The current may be converted to a voltage by a current-voltage conversion device. By sweeping the propagation time in which the probe light 720 reaches the detection unit 708 with the delay unit 709 that includes a movable retroreflector or the like, the temporal waveform of the electric-field intensity of the terahertz wave 706 can be reconstructed.

The delay unit 709 changes the optical path length of the probe light 720 so as to generate a difference between the optical path length of the pumping light 721 and the optical path length of the probe light 720. Through this configuration, the optical path length of the probe light 720 changes relative to the optical path length of the pumping light 721 and the terahertz wave 706, and thus timings at which the probe light 720 and the terahertz wave 706 reach the detection unit 708 vary. Instead of the optical path length of the probe light 720, the optical path length of the pumping light 721 may be changed. It is sufficient if the delay unit 709 is configured to vary the timings at which the probe light 720 and the terahertz wave 706 reach the detection unit 708. For example, a light source that outputs the pumping light and another light source that outputs the probe light may be provided, and the timings at which the two light sources output the pumping light and the probe light may be varied.

A processing unit 710 controls the propagation time of the probe light 720 through the delay unit 709 or obtains information on the sample 707. Specific examples of the information on the sample 707 include the temporal waveform of the terahertz wave 706, a spectrum obtained from the temporal waveform, the optical properties of the sample 707, and the layer condition and the shape of the sample 707. It is to be noted that the optical properties as used in the present specification include a complex amplitude reflectance, a complex refractive index, a complex dielectric constant, a reflectance, a refractive index, an absorption coefficient, a dielectric constant, an electrical conductivity, and so on of the sample. The obtained information on the sample 707 is displayed on a display unit 711.

On the basis of intervals of times at which the temporal waveforms of the terahertz waves 706 reflected by the surface of the sample 707 and by interfaces inside the sample 707 are detected, interlayer spacing in the sample 707 can also be evaluated (time-of-flight method). Furthermore, by changing the relative positions of the sample 707 and the terahertz wave 706 and by scanning the irradiation position of the terahertz wave 706 on the sample 707, tomographic imaging can be carried out, and the shape or the like of a region having predetermined optical properties within a specimen can be obtained. Although the apparatus 700 detects the terahertz wave 706 reflected by the sample 707, the apparatus 700 may detect a terahertz wave that has passed through the sample 707. On the basis of the obtained information on the sample 707, identification, imaging, or the like of the sample 707 can be carried out, and by utilizing such a feature, the apparatus 700 can be used in the fields of medicine, cosmetics, industrial product inspection, food, and so on.

The generation unit 704 according to the present exemplary embodiment is constituted by the terahertz-wave generation device of any of the above-described exemplary embodiments. Therefore, the generation unit 704 causes light obtained as the control unit 5 subjects the pumping light 721 to high-speed polarization modulation of up to several hundred MHz to be incident on the crystal 6. Consequently, the modulation range is broad, and the terahertz wave 706 whose intensity has been modulated stably can be obtained. Through such a configuration, the speed at which the temporal waveform is obtained is increased, and the dynamic range is broadened. Thus, the apparatus 700 can carry out a measurement with high accuracy. In addition, a measurement apparatus that can stably supply a high-power terahertz wave for an extended period of time can be manufactured.

In addition, since the generator 12 is configured to have a waveguide structure as in the above-described exemplary embodiments, the Cherenkov radiation angle θ_{c} changes in accordance with the polarization state of the light 10. Therefore, the irradiation position of the terahertz wave 706 on the detection unit 708 can be changed. Thus, by controlling the polarization direction of the pumping light 721, in addition to the intensity modulation of the terahertz wave 706, intensity modulation in the detection unit 708 occurs in accordance with a change in the propagation angle of the terahertz wave 706. In particular, in a case in which a photoconductive element that is sensitive to the incident position of the terahertz wave 706 is used for the detection unit 708, as in the present exemplary embodiment, the intensity of the terahertz wave 706 to be detected can be changed greatly.

### Seventh Exemplary Embodiment

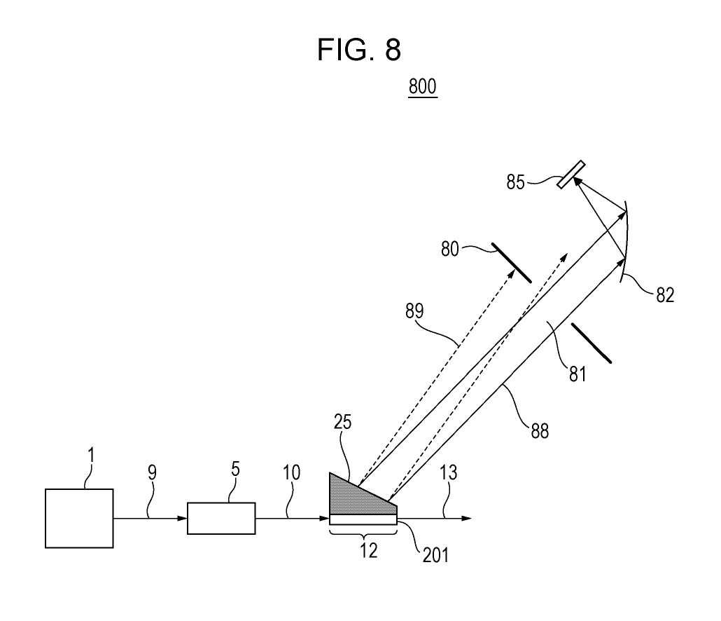

A configuration of a terahertz-wave generation device 800 (hereinafter, referred to as the device 800) according to a seventh exemplary embodiment will be described. FIG. 8 illustrates the configuration of the device 800. The device 800 includes, in addition to the components of the device 100 according to the first exemplary embodiment, a slit constituting unit 80 disposed in a propagation path of terahertz waves 88 and 89 emitted from the generator 12. A slit 81 in the slit constituting unit 80 is formed by two plates that extend in the direction parallel to the paper plane. Descriptions of the configurations that are similar to those of the first exemplary embodiment will be omitted.

As described above, when the crystal 6 constituting the generator 12 is birefringent, as the angle formed by the polarization direction of the light 10 incident on the generator 12 and the pyro axis of the crystal 6 changes, the angle at which the terahertz waves are radiated or the Cherenkov radiation angle changes.

As an example, propagation of the terahertz waves 88 and 89 generated in the device 800 when the wavelength of the light 10 is in a 1.55-μm band, the crystal 6 is LiNbO₃, and the coupling member 25 is a high-resistance Si will be described. Here, the assumption is that the terahertz waves 88 and 89 illustrated in FIG. 8 are terahertz waves of 1 THz. The refractive index of the crystal 6 for the terahertz wave 88 excited by a polarization component of the light 10 that coincides with the direction of the Z-axis is 2.14. Thus, the Cherenkov radiation angle θ_{c} is approximately 65 degrees, and the angle θ_{clad} formed by the terahertz waves 88 and 89 propagating through the coupling member 25 and the surface of the substrate 20 is approximately 49 degrees. In the meantime, the refractive index of the crystal 6 for the terahertz wave 89 excited by a polarization component of the light 10 that is orthogonal to the direction of the Z-axis of LiNbO₃ is 2.21. Thus, the Cherenkov radiation angle θ_{c} is approximately 71 degrees, and the angle θ_{clad} is approximately 51 degrees.

In a case in which the upper clad layer 24 in the waveguide 201 illustrated in FIG. 2A is as sufficiently thin as no more than 1/20 of the wavelength of the terahertz waves 88 and 89, it may be difficult to define the Cherenkov radiation angle θ_{c}. However, even in such a case, the angle θ_{clad} formed by each of the terahertz waves 88 and 89 and the surface of the substrate can be calculated from the refractive index of the coupling member 25 and the refractive index of the crystal 6.

In this manner, by rotating the polarization direction of the light 10 by 90 degrees from the angle at which the polarization direction coincides with the direction of the Z-axis of LiNbO₃, the propagation path of the terahertz waves 88 and 89 can be varied by approximately 2 degrees. Consequently, when the terahertz waves 88 and 89 travel 1 m, the positions where the terahertz waves 88 and 89 reach differ by approximately 3.5 cm. Therefore, in addition to the intensity of the terahertz waves 88 and 89 being modulated by modulating the light 10 to be incident on the generator 12, the incident positions of the terahertz waves 88 and 89 on a detection unit 85 that detects the terahertz waves generated in the device 800 can be modulated.

In addition, the slit 81 is provided by the use of the slit constituting unit 80 in the present exemplary embodiment. The slit constituting unit 80 is disposed such that the terahertz wave 88 radiated when the polarization direction of the light 10 coincides with the direction of the Z-axis of LiNbO₃ serving as the crystal 6 is not blocked. The terahertz wave 88 that has passed through the slit 81 can be converged by a parabolic mirror 82 and be incident on the detection unit 85. In the meantime, the propagation direction of the terahertz wave 89 is shifted by approximately 2 degrees from the propagation direction of the terahertz wave 88, as described above. Therefore, most of the terahertz wave 89 is blocked by the slit constituting unit 80 and does not pass through the slit 81. It is to be noted that the slit 81 can be in any shape that achieves the function of blocking the terahertz wave 89 and so on that have propagated through a portion other than a desired path, and can be a circular opening. In addition, it is desirable that the slit constituting unit 80 be formed of a material, such as metal, that is less likely to transmit the terahertz wave.

Consequently, the terahertz wave 89 is less likely to be incident on the detection unit 85, and thus the modulation range can be further broadened. The slit 81 may be provided so as to be spaced apart from the generator 12 as much as possible, and thus the modulation range can be further broadened.

### Implementation Example

In an implementation example, the configuration of the device 100 according to the first exemplary embodiment will be described in further detail. The device 100 according to the present implementation example includes the generator 12 that is constituted by a terahertz-wave generator utilizing the Cherenkov radiation, such as the one illustrated in FIGS. 2A and 2B.

The light source 1 is constituted by a laser device that outputs the light 9 at a central wavelength of 1.55 μm, with a pulse duration of 20 fs, at a repetition rate of 50 MHz, and with a power of 200 mW. The polarization state 7 of the light 9 is linear in which the polarization extinction ratio is no less than 20 dB.

The control unit 5 includes the electrodes 2 and 3 and the crystal 4, and the crystal 4 is disposed between the electrode 2 and the electrode 3. The crystal 4 is formed by MgO-doped LiNbO₃ so as to prevent an optical damage, and the electrodes 2 and 3 are constituted by aluminum electrodes. The crystal 4 containing MgO-doped LiNbO₃ has sufficient durability that does not experience an optical damage to be caused by the intensity of the light 9. The crystal 4 has a thickness of 2 mm and a length of approximately 10 mm in the direction in which the light 9 travels. In the control unit 5, as a voltage of 100 V is applied across the electrode 2 and the electrode 3, the polarization direction of the light 9 can be rotated by 90 degrees from the polarization direction held prior to being incident on the control unit 5. When an influence of dispersion or the like of the light 9 is to be reduced, the length of the control unit 5 in the direction in which the light 9 travels may be reduced, and the voltage applied across the electrode 2 and the electrode 3 may be increased.

In the control unit 5, in order to use r33 at which the nonlinear optical coefficient serving as an index of the nonlinear optical effect is maximum, the electrodes 2 and 3 are provided along the crystal planes that are orthogonal to the pyro axis (Z-axis) of the LiNbO₃ crystal serving as the crystal 4. When the control unit 5 is disposed such that the polarization direction of the light 9 is at an angle of 45±5 degrees relative to the pyro axis, the polarization can be controlled with high efficiency. In addition, the control unit 5 is disposed such that the direction in which the light 9 travels coincides with the X-axis of the crystal 4. A SiO₂ film (not illustrated) serving as an anti-reflection film is disposed on a face of the control unit 5 on which the light 9 is incident or from which the light 10 is emitted. The thickness of the SiO₂ film is approximately 263 nm, so that the optical length is ¼ of 1.55 μm, which is the central wavelength of the light 9 and 10. The SiO₂ film is formed through sputtering, but can also be formed through chemical vapor deposition (CVD) or the like.

With the configuration described above, the polarization of the light 9 can be modulated by applying a voltage with a desired modulation frequency across the electrodes 2 and 3. As described in the first exemplary embodiment, the modulation frequency needs to be set cautiously, and needs to be set outside the structural resonant frequency of the crystal 4. Although this resonant frequency varies depending on the shape of the piezoelectric constant of the crystal 4, the resonant frequency often lies within a range from 1 MHz to 10 MHz inclusive, and can be obtained through an inspection.

In the present implementation example, when an alternating current voltage of 100 V at 100 kHz is applied across the electrodes 2 and 3, the polarization direction of the light 9 in the polarization state 7 can be modulated by 90 degrees at 100 kHz without the control unit 5 resonating. This result greatly exceeds several kHz, which is an upper limit frequency obtained when the modulation is carried out with an optical chopper. The light 10 whose polarization state has been controlled by the control unit 5 is incident on the crystal 6 in the generator 12.

The generator 12 is a terahertz-wave generator that utilizes the Cherenkov radiation and is configured similarly to the generator 12 according to the first exemplary embodiment. Specifically, the generator 12 includes the waveguide 201, the coupling member 25, and the substrate 20. The waveguide 201 includes the crystal 6, the adhesion layer 21, the lower clad layer 22, and the upper clad layer 24. When laser light that is polarized in a direction parallel to the pyro axis (Z-axis) of the crystal 6, or in other words, laser light of horizontal polarization is incident on the crystal 6 in the waveguide 201 and propagates along the X-axis, the terahertz wave 26 is emitted from the crystal 6, and the terahertz wave 26 can be extracted to a space through the coupling member 25.

The crystal 6 is formed of LiNbO₃. Therefore, the effective nonlinear optical constant in the direction of the pyro axis (Z-axis) of the crystal 6 is d₃₃=34.4 pm/V, which is greater than the effective nonlinear optical constants d₃₁=5.95 pm/V and d₂₂=3.07 pm/V in other axial directions. Thus, the intensity of the terahertz wave 26 radiated from the generator 12 is determined substantially by a component of the light 9 that has a polarization direction that coincides with the pyro axis of the crystal 6. Therefore, the intensity of the terahertz wave 26 can be adjusted by adjusting the pyro axis component of the light 10 to be incident on the generator 12 by using the control unit 5.

The substrate 20 used in this implementation example is a Y-cut LiNbO₃ substrate and is disposed such that the X-axis of LiNbO₃ of the substrate 20 extends in the direction in which the light 9 travels and the Z-axis extends in the direction that is orthogonal to the direction in which the light 9 travels and that is parallel to the substrate 20. Through such a configuration, when polarized light having an electric field component parallel to the Z-axis is incident on the substrate 20, the terahertz wave 26 can be emitted with high efficiency through the Cherenkov radiation, which is a second-order nonlinear phenomenon.

The waveguide 201 propagates incident laser light through total reflection by the waveguide layer 6 (crystal 6) that is formed by MgO-doped LiNbO₃ crystal layers. The crystal axis of the crystal 6 coincides with the axial direction of the substrate 20. The lower clad layer 22 and the substrate 20 are affixed by the adhesion layer 21 that includes an acrylic adhesive. The upper clad layer 24 is formed of SiO₂ through CVD. The coupling member 25 having a refractive index that is greater than the refractive index of LiNbO₂ serving the crystal 6 is provided on the upper portion of the waveguide 201 for extracting the generated terahertz wave 26 to the outside. The coupling member 25 is formed of a high-resistance Si prism that does not cause much loss of the terahertz wave 26, and as in the first exemplary embodiment, the coupling member 25 has a truncated cone shape so as to have a function of converging the terahertz wave 26 only in one direction.

The structure of the waveguide 201 in the lateral direction is formed such that a ridge shape is formed through etching, which is then protected by being surrounded by SiO₂. Although a waveguide structure is also formed in the lateral direction in order to confine more light, a slab waveguide that does not include a confinement region and in which the crystal 6 extends uniformly in the lateral direction may instead be used.

As described above, it is desirable that the upper clad layer 24 be thick enough for the upper clad layer 24 to function as a clad layer when the light 10 propagates through the crystal 6 and be thin enough that the influence of multi-reflection or a loss caused when the terahertz wave 26 is radiated to the outside through the coupling member 25 can be ignored. In the present implementation example, the waveguide layer (crystal) 6 has a thickness of 3.8 μm and a width of 4 μm, and the upper clad layer 24 has a thickness of 1 μm.

In the present implementation example, through Expression (2) above, the Cherenkov radiation angle of the terahertz wave excited by a component of the light 10 that coincides with the direction of the Z-axis of LiNbO₃ is approximately 65 degrees. The coupling member 25 is formed suitably of a material that allows the terahertz wave to be extracted into the air without being totally reflected in the waveguide 201, such as high-resistance Si that does not cause much loss of the terahertz wave 26. In this case, the angle θ_{clad} formed by the terahertz wave 26 propagating through the coupling member 25 and the surface of the substrate is approximately 49 degrees.

The generator 12 according to the present implementation example is disposed such that the pyro axis of the crystal 6 coincides with the polarization direction of the light 9 in the polarization state 7. The control unit 5 can adjust the polarization state 7 of the light 9 held prior to the light 9 passing through the control unit 5 to the state of elliptical polarization as in the polarization state 8 and then to the polarization state of the light 10 that is linearly polarized light polarized at an angle of 90 degrees relative to the polarization direction in the polarization state 7. By obtaining the light 10 whose polarization direction has been changed by 90 degrees from the polarization direction in the polarization state 7, the terahertz wave 26 can be subjected to intensity control at an extinction ratio of approximately 100:1.

To be more specific, when the light 10 has become linearly polarized light that is polarized at an angle of 90 degrees relative the direction of the Z-axis of LiNbO₃, the angle θ_{clad} formed by the terahertz wave 26 propagating through the coupling member 25 and the surface of the substrate is approximately 51 degrees. Therefore, by rotating the polarization angle of the light 10 by 90 degrees, the angle of the propagation path of the terahertz wave 26 can be changed by approximately 2 degrees. For example, when the terahertz wave 26 travels 1 m, the position thereof shifts by approximately 3.5 cm. In this manner, in addition to the intensity modulation of the terahertz wave 26 on the detection unit, the position of the detection unit that the terahertz wave 26 reaches can be modulated, and the modulation range can be further broadened.

Consequently, when an alternating current voltage of 100 V at 100 kHz is applied across the electrodes 2 and 3, intensity modulation at an extinction ratio of approximately 100:1 can be achieved at 100 kHz. As for the modulation speed, by optimizing the size of the control unit 5, the speed can typically be increased up to several hundred MHz.

According to the device 100, the light 10 obtained by subjecting the light 9 to high-speed polarization modulation of up to several hundred MHz is incident on the crystal 6 in the generator 12. Therefore, the modulation range is broad, and the terahertz wave 26 whose intensity has been modulated stably can be obtained. In addition, when the polarization state of the light 10 is controlled, the output of the terahertz wave 26 can be adjusted accordingly. Therefore, the terahertz wave 26 can be supplied stably for an extended period of time.

Although the exemplary embodiments of the present inventions have been described thus far, the present inventions are not limited to these exemplary embodiments, and various modifications and changes can be made within the spirit of the present inventions.

For example, although the apparatus 700 according to the sixth exemplary embodiment detects the terahertz wave 26 reflected by the sample 707, the apparatus 700 may detect the terahertz wave 26 that has passed through the sample 707.

In the exemplary embodiments described above, the arrangements of the control unit 5 that are desirable in terms of controlling the polarization state of the light 9 with high efficiency by using the control unit 5 have been described. In addition, in the control unit 5 of the exemplary embodiments described above, the two electrodes 2 and 3 are disposed so as to be perpendicular to any one of the X-axis, the Y-axis, and the Z-axis of the crystal 4. However, this is not a limiting example, and it is sufficient if the electrode 2 and the electrode 3 in the control unit 5 are disposed so as to face each other. Furthermore, it is sufficient if the control unit 5 is disposed such that the angle formed by the direction of the electric field formed between the electrode 2 and the electrode 3 and the polarization direction of the light 9 is 45±5 degrees.

While the present inventions have been described with reference to exemplary embodiments, it is to be understood that the inventions are not limited to the disclosed exemplary embodiments. The scope of the following claims is to be accorded the broadest interpretation so as to encompass all such modifications and equivalent structures and functions.

This application claims the benefit of Japanese Patent Application No. 2014-093887, filed Apr. 30, 2014, and Japanese Patent Application NO. 2015-056430, filed Mar. 19, 2015, which are hereby incorporated by reference herein in their entirety.

What is claimed is:

1. A terahertz-wave generation device configured to generate a terahertz wave, comprising:
a polarization control unit configured to control a polarization direction of light from a light source; and
a waveguide including a nonlinear optical crystal disposed such that, when the light having the polarization direction controlled by the polarization control unit is incident on the nonlinear optical crystal, the nonlinear optical crystal emits a terahertz wave upon the light being incident thereon,
wherein the polarization control unit is further configured to control an electric-field intensity of the light to be incident on the nonlinear optical crystal in a direction of a Z-axis of the nonlinear optical crystal.

2. The terahertz-wave generation device according to claim 1, further comprising:
an optical detection unit configured to detect light emitted from the nonlinear optical crystal,
wherein the polarization control unit is further configured to control the polarization direction of the light to be incident on the nonlinear optical crystal on the basis of a result of a detection by the optical detection unit.

3. The terahertz-wave generation device according to claim 2, further comprising:
a polarizer configured to extract light, from the light emitted from the nonlinear optical crystal, that is polarized in the direction of the Z-axis,
wherein the optical detection unit is further configured to detect the light from the polarizer.

4. The terahertz-wave generation device according to claim 1,
wherein the polarization control unit periodically changes the electric-field intensity of the light to be incident on the nonlinear optical crystal in the direction of the Z-axis.

5. The terahertz-wave generation device according to claim 1,
wherein the polarization control unit includes a first electrode, a second electrode, and a nonlinear optical crystal disposed between the first electrode and the second electrode.

6. The terahertz-wave generation device according to claim 5,
wherein the polarization control unit is disposed such that an angle formed by a direction of an electric field formed between the first electrode and the second electrode and the polarization direction of the light to be incident on the polarization control unit is 45±5 degrees.

7. The terahertz-wave generation device according to claim 6,
wherein the polarization control unit is a first polarization control unit, and a second polarization control unit that is different from the first polarization control unit is further provided,
wherein the second polarization control unit includes a third electrode, a fourth electrode, and a nonlinear optical crystal disposed between the third electrode and the fourth electrode,
wherein the second polarization control unit is disposed such that an angle formed by a direction of an electric field formed between the third electrode and the fourth electrode and the direction of the electric field formed between the first electrode and the second electrode is 90±5 degrees, and
wherein the second polarization control unit is disposed such that an angle formed by the direction of the electric field formed between the third electrode and the fourth electrode and a polarization direction of the light to be incident on the second polarization control unit is 45±5 degrees.

8. The terahertz-wave generation device according to claim 1, further comprising:
a coupling member disposed so as to be in contact with the nonlinear optical crystal and configured to extract the terahertz wave emitted from the nonlinear optical crystal in the waveguide to an area or location outside of the waveguide.

9. The terahertz-wave generation device according to claim 1,
wherein the terahertz wave emitted from the nonlinear optical crystal in the waveguide is radiated through Cherenkov radiation.

10. The terahertz-wave generation device according to claim 1,
wherein the waveguide includes the nonlinear optical crystal in the waveguide, a first clad layer, and a second clad layer,
wherein the nonlinear optical crystal in the waveguide is disposed between the first clad layer and the second clad layer, and
wherein refractive indices of the first and second clad layers for a wavelength of the terahertz wave are less than a refractive index of the nonlinear optical crystal for the terahertz wave.

11. The terahertz-wave generation device according to claim 10,
wherein the nonlinear optical crystal in the waveguide has a width that is less than the wavelength of the terahertz wave.

12. The terahertz-wave generation device according to claim 1,
wherein the nonlinear optical crystal in the waveguide includes any one of Lithium Niobate (LiNbO₃), Lithium Tantalate (LiTaO₃), Niobium Tantalate (NbTaO₃), Potassium titanyl phosphate (KTP), Diethylaminosulfur trifluoride (DAST), Zinc Telluride (ZnTe), Gallium Selenide (GaSe), and Gallium Arsenide (GaAs).

13. The terahertz-wave generation device according to claim 5,
wherein the nonlinear optical crystal in the polarization control unit includes any one of Lithium Niobate (LiNbO₃), Lithium Tantalate (LiTaO₃), Niobium Tantalate (NbTaO₃), Potassium titanyl phosphate (KTP), Diethylaminosulfur trifluoride (DAST), Zinc Telluride (ZnTe), Gallium Selenide (GaSe), and Gallium Arsenide (GaAs).

14. The terahertz-wave generation device according to claim 6,
wherein the nonlinear optical crystal in the polarization control unit includes any one of Lithium Niobate (LiNbO₃), Lithium Tantalate (LiTaO₃), Niobium Tantalate (NbTaO₃), Potassium titanyl phosphate (KTP), Diethylaminosulfur trifluoride (DAST), Zinc Telluride (ZnTe), Gallium Selenide (GaSe), and Gallium Arsenide (GaAs).

15. The terahertz-wave generation device according to claim 7,
wherein the nonlinear optical crystals in the first polarization control unit and the second polarization control unit each include any one of Lithium Niobate (LiNbO₃), Lithium Tantalate (LiTaO₃), Niobium Tantalate (NbTaO₃), Potassium titanyl phosphate (KTP), Diethylaminosulfur trifluoride (DAST), Zinc Telluride (ZnTe), Gallium Selenide (GaSe), and Gallium Arsenide (GaAs).

16. The terahertz-wave generation device according to claim 1,
wherein the polarization control unit is provided with an anti-reflection film disposed on one of a face on which the light from the light source is incident and a face from which the light is emitted.

17. The terahertz-wave generation device according to claim 1,
wherein the polarization control unit is in contact with the waveguide.

18. A measurement apparatus configured to measure a terahertz wave, comprising:
the terahertz-wave generation device according to claim 1; and
a detection unit configured to detect the terahertz wave.

19. A method for generating a terahertz wave, comprising the steps of:
controlling a polarization direction of light from a light source; and
causing the light, having the polarization direction controlled in the step of controlling, to be incident on a nonlinear optical crystal so as to generate the terahertz wave,
wherein, in the step of controlling, an electric-field intensity of the light to be incident on the nonlinear optical crystal in a direction of a Z-axis of the nonlinear optical crystal is controlled.
